(19) United States
(12) Patent Application Publication
(10) Pub. No.: US 2014/0131291 A1
(43) Pub. Date: May 15, 2014

(54) DEVICE FOR SEPARATING SOLID PARTICLES FROM LIQUID, AND USE THEREOF

(71) Applicant: Ivo Schumacher, Varikon (CH)

(72) Inventor: Ivo Schumacher, Varikon (CH)

(73) Assignee: DRM, DR. MÜLLER AG, Männedorf (CH)

(21) Appl. No.: 14/124,942

(22) PCT Filed: Mar. 15, 2012
(86) PCT No.: PCT/CH2012/000061

§ 371 Date: Dec. 9, 2013

(30) Foreign Application Priority Data
Jul. 28, 2011 (CH) 1262/11

(51) Int. Cl. B01D 29/56

(52) U.S. Cl. CPC B01D 29/56
USPC 210/767; 210/335

(57) ABSTRACT

A device for separating solid particles from liquids includes a pressure vessel and one or more filter element registers having filter elements disposed in suspension on a horizontal filtrate discharge pipe. Each of the filter elements is formed from a substantially flat support mesh, a completely enclosed filter medium and spacers suspended therebetween. The support mesh is formed of rolled-flat mesh pipes that are smooth on an outside of the mesh pipes and, in an interior thereof, include longitudinal webs arranged to form channels that permit filtrate to flow to the horizontal discharge pipe.

The invention relates to a device for separating solid particles from liquids, comprising a pressure vessel and one or more filter element registers having filter elements disposed in suspension on a horizontal filtrate discharge pipe, wherein the filter elements comprise a substantially flat support mesh, a completely enclosed filter medium, and spacers suspended therebetween, wherein the invention also relates to the use thereof.

Devices for separating solid particles from liquids and gasses for installation in a pressure vessel in the form of a register, to which filter elements are attached, are known. Such filter elements are intended for use to separate out large quantities of solids, in particular from liquids.

EP 0556 188 describes a tubular filter, in which filter candles, which are combined with a cylindrical support fabric in a register, are installed in a pressure vessel. Although the known tubular filter is suitable for separating out large quantities of solids, the filter elements occupy too great of a volume for small quantities of solids, and so the pressure vessel becomes unnecessarily large and costly.

Document DE OS 2114226 describes a filter, in which filter tubes are made of a permeable, flexible jacket. Support inserts made of plastic having openings are located inside the filter tubes. Instead of a support cylinder or a wire spiral, it is also possible to provide a sheet made of metal or plastic having slots. Instead of slots, a sheet material having a number of circular openings or perforations is also proposed. The known designs are very complex in terms of the manufacture of the pressure-resistant, tubular filter elements. A further disadvantage is the volume required by the filter elements in the pressure vessel.

In addition, document DE OS 28 18 340 describes a liquid-solid filter, in which tubular filter elements are drawn over axially parallel support rods. The support rods are made of a solid metal and impart stability to the filter element but also add a great deal of weight thereto.

A filter apparatus for thickening suspensions is known from U.S. Pat. No. 4,511,471. A pressure vessel contains a tubular filter element in the form of pipes. The spaces between the filter pipes are separated by vertical metal walls. Therefore, a relatively small filter area occupies a very large amount of space.

US 2003121855 A1 makes known a membrane filter, which is also known as an ultrafilter. The modules comprise membranes, which form a hollow body. The membrane modules are fixed at the upper and lower ends or corners thereof, in order to create opens spaces therebetween for the liquid to be filtered. Flexible hangers are provided therebetween, as spacers, in order to prevent compression of the membranes during ultrafiltration. This is a complex retaining construction for maintaining an open space. In addition to the complexity and the costs, the retaining construction has the disadvantage that the filter membranes are exposed to additional mechanical loads at these positions.

Document JP 8131783 also relates to a membrane filter having bag-type membranes, which are disposed side-by-side. Spacers hanging between filter elements are disposed in an open container. A device for introducing air is provided underneath the filter pack.

The problem addressed by the invention is that of accommodating the greatest possible filter area in the smallest possible space such that the depositing solid can nevertheless be cyclically rinsed out of the filter in a concentrated form.

The problem is solved according to the invention in that support meshes are made of rolled-flat mesh pipes, which are smooth on the outer side thereof. This means that the outer side has a smooth surface without ribs. The flat support meshes have the advantage that they occupy a small volume in the pressure vessel and are pressure-resistant despite the small amount of material. A smooth surface prevents residue from adhering to filter cakes after backwashing when the filter elements are cleaned.

The support meshes have longitudinal webs in the interior thereof, which are designed such that channels form, which permit the filtrate to flow to the filtrate discharge pipe. This has the advantage that the filtrate outflow is unobstructed.

The vertically disposed filter elements are advantageously suspended on the horizontal filtrate discharge tube such that the suspension fed through the intake from above arrives between the filter elements and a large number of filter elements can be easily connected to the filtrate discharge.

It is advantageous to produce the support meshes out of plastic. This has the advantage of production utilizing a minimal amount of material, low weight for suspension in the filter, and simple assembly.

The filter elements are attached via the upper half of the length thereof, suspended on a horizontally disposed filtrate discharge pipe, wherein spacers hang between the filter elements. The flat support mesh has the advantage that pressure-resistant filter elements can be produced using a minimal amount of material, and these filter elements occupy a minimal volume. By means of the spacers hanging between the filter elements, it is also possible to reduce the space between the filter elements to a necessary minimum.

The spacers are also advantageously made of plastic.

By means of the liquid fed through the filtrate discharge, the solid deposited on the filter elements is removed and displaced downwardly to the concentrate outlet.

The filter packs are disposed in the pressure vessel such that, during backwashing, these filter packs are supported by the walls of the pressure vessel or separating walls provided therefor in such a way that these filter packs cannot expand further than is permissible, in order to prevent damage to the filter elements.

The spacers terminate at the upper and lower edges thereof along with the filter elements and comprise vertical longitudinal webs, which are designed such that these extend toward the filter element, and the solid removed during backwashing can be rinsed downward to the concentrate outlet.

The spacers between the filter elements comprise an elastomer or plastic and seals comprising an elastomer between the spacer and the filter element. This has the advantage that the distance between the elements can be adapted to the process conditions of an application, if necessary.

The use of the device is suited, in particular, for the filtration of solids from a liquid having a particle size of 0.1 to 10 micrometers and a solid content of the suspension to be filtered of 1 mg/l to 5000 mg/l.

The invention is explained in greater detail by reference to drawings. Therein:

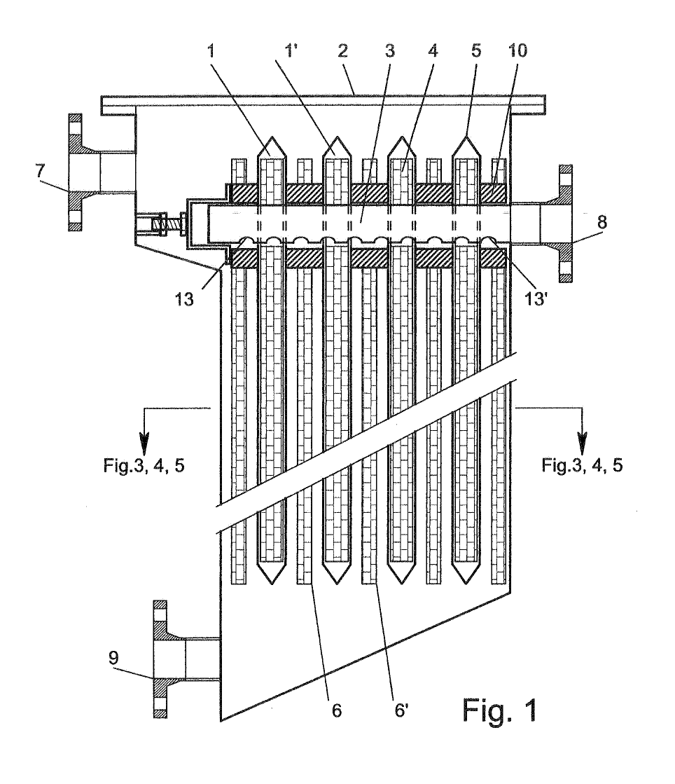

FIG. 1 shows a filter housing having internals, in a lateral cross-section.

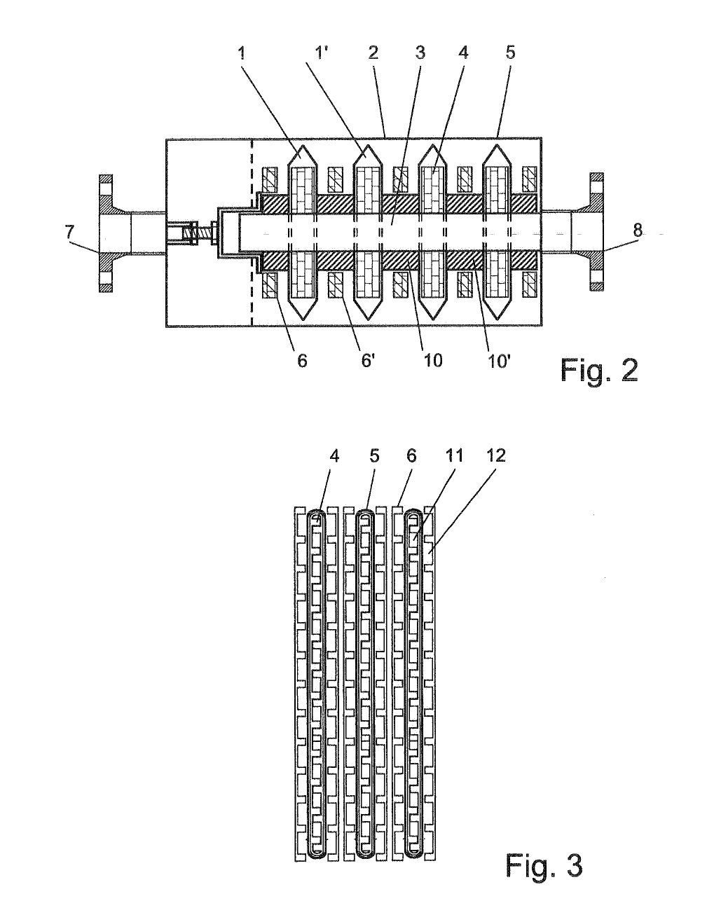

FIG. 2 shows a filter housing having internals, in a cross-section from above.

FIG. 3 shows a more detailed cross-section of the filter elements from above.

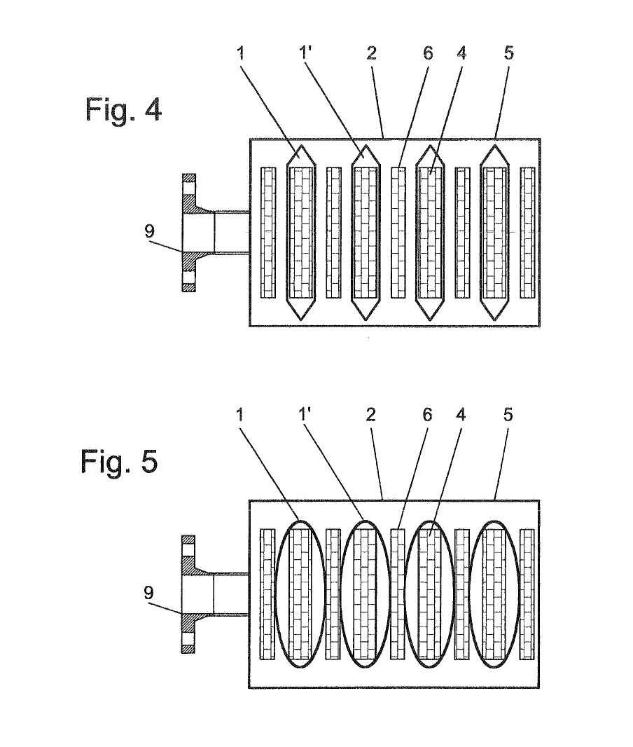

FIG. 4 shows a cross-section of the filter housing according to FIG. 1, during filtration.

FIG. 5 shows a cross-section of the filter housing according to FIG. 1, during backwashing.

In FIG. 1, filter elements are labelled with reference signs 1,1′. The filter elements 1, 1′ are attached in a pressure vessel 2, suspended on a horizontal filtrate discharge pipe 3 having filtrate discharge holes 13, 13′. Flat support meshes 4 are provided inside the filter elements 1, 1, which are enclosed by a completely closed filter medium 5. The pressure vessel 2 is equipped with a connector 7, a connector 8, and a connector 9.

Spacers 6, 6′ are provided between the individual filter elements 1, 1′. The spacers 6, 6′ do not extend beyond the filter elements 1, 1′, either in the lower or upper part thereof.

FIG. 2 shows internals, in a cross-section from above, wherein identical parts are described using the same reference signs as in FIG. 1.

FIG. 3 shows the support mesh 4, the filter medium 5, the spacers 6, the filtrate discharge channels 11, and the suspension channels 12 of the filter elements 1,1′.

FIG. 4 shows a cross-section of the filter housing according to FIG. 1, during filtration.

FIG. 5 shows a cross-section of the filter housing according to FIG. 1, during backwashing.

During operation, a material to be filtered is fed into the pressure vessel 2 via the connector 7. From the pressure vessel 2, the material to be filtered flows through the filter medium 5 and exits the pressure vessel 2 as clear filtrate via the filtrate discharge channels 11 of the flat support mesh 4 and the horizontal filtrate discharge pipe 3. The solid contained in the suspension is thereby retained by the filter medium 5 and deposits onto the surface of the filter medium 5. After filtration is completed, the filter elements are cleaned via backwashing or backblowing. The spacers 6 prevent the surfaces of the filter media from pressing against one another upon expansion and clamping the solid therebetween. The removed solid is rinsed out of the intermediate space of the filter elements through the suspension channels 12, thereby permitting a concentrate of the solid to be removed via the connector 9 at the lower end of the pressure vessel 2.

The usability of the invention was tested by means of a prototype. To this end, five filter elements having a thickness of <12 mm and a width of 155 mm and a length of 2000 mm were installed in a pressure vessel. The active filter area was 3 m² and the container volume was less than 80 liters, or 27 liters pro m². This is a significant difference compared to known backwashable pressure filters.

1. A device for separating solid particles from liquids, comprising:
a pressure vessel, and
one or more filter element registers having filter elements disposed in suspension on a horizontal filtrate discharge pipe,
wherein each of the filter elements comprise a substantially flat support mesh, a completely enclosed filter medium and spacers suspended therebetween, and
wherein the support mesh is formed of rolled-flat mesh pipes that are smooth on an outside of the mesh pipes and, in an interior thereof, include longitudinal webs arranged to form channels that permit filtrate to flow to the horizontal filtrate discharge pipe.

2. (canceled)

3. The device according to claim 1, wherein the support mesh is made of a plastic.

4. The device according to claim 1, wherein the spacers comprise longitudinal webs.

5. The device according to claim 4, wherein the spacers are made of a plastic.

6. The device according to claim 1, wherein a sealing of the spacers between the filter elements comprises an elastomer.

7. A method of using the device according to claim 1, comprising:
filtering solid particles from a liquid, wherein the liquid has a particle size in a range of between 0.1 and 10 micrometers and a solid content in a range of between 1 mg/l and 5000 mg/l.
